(19) United States
(12) Patent Application Publication
(10) Pub. No.: US 2020/0230810 A1
(43) Pub. Date: Jul. 23, 2020

(54) Humanoid Robot Joint Designs

(71) Applicant: Florida Institute for Human and Machine Cognition, Inc., Pensacola, FL (US)

(72) Inventor: Victor Ragusila, Pensacola, FL (US)

(73) Assignee: Florida Institute for Human and Machine Cognition, Inc., Pensacola, FL (US)

(21) Appl. No.: 16/748,203

(22) Filed: Jan. 21, 2020

Related U.S. Application Data
(60) Provisional application No. 62/794,182, filed on Jan. 18, 2019.

(51) Int. Cl. B25J 9/10; F16H 19/06; B25J 17/02

(52) U.S. Cl. CPC B25J 9/104; F16H 2019/0695; B25J 17/02; F16H 19/0622

(57) ABSTRACT

A robotic joint wherein a second link is driven relative to a first link. An intermediate link connects the second link to the first link. The first link includes a first arcuate surface centered on a first axis. The second link includes a second arcuate surface centered on a second axis. The radius of the first arcuate surface is equal to the radius of the second arcuate surface. The intermediate link is pivotally connected to the first axis and pivotally connected to the second axis. First and second cables are provided. The first cable runs around the first arcuate surface in a first direction and runs around the second arcuate surface in a second direction that is opposite to the first direction. The second cable runs around the second arcuate surface in the first direction and around the first arcuate surface in the second direction. Tension is maintained on both cables.

### CROSS-REFERENCES TO RELATED APPLICATIONS

This non-provisional patent application claims the benefit—pursuant to 37 C.F.R. § 1.53(c)—of a provisional patent having Ser. No. 62/794,182. The provisional patent application listed the same inventors.

### STATEMENT REGARDING FEDERALLY SPONSORED RESEARCH OR DEVELOPMENT

Not applicable

### MICROFICHE APPENDIX

Not Applicable

### BACKGROUND OF THE INVENTION

### 1. Field of the Invention

The present invention pertains to the field of robotics. More specifically, the invention comprises a joint design configured to amplify the motion of an actuator.

### 2. Description of the Related Art

One of the goals of robotics is to approximate the performance of human and animal joints. Human and animal joints typically have a large number of degrees of freedom and a large range of motion. Creating robotic joints having a similar range of motion is difficult. Nature achieves a large range of motion for a particular limb through the use of a connecting joint having a large range of angular travel. The human hip and shoulder ball-and-socket joints are good examples. These joints are connected by multiple ligaments and muscle groups that stabilize the geometry and apply suitable forces throughout the large range of travel. Due to the large number of muscle fibers attached across a joint, no matter what position the joint is in, there is a muscle with a favorable orientation to actuate the joint. Therefore, biological joints do not suffer from singularities or range of motion constraints.

In contrast, typical robot joints have restricting range of motion constraints. For example, a one degree-of-freedom pin joint actuated by a piston has a limited range of motion. This range of motion can be increased by using a four bar mechanism, which is commonly used on backhoes and various robot limbs. Two degree-of-freedom universal joints can be actuated with two pistons utilizing a set of four bar mechanisms. However, universal joints suffer from limited range of motion due to structural limitations when components collide and due to kinematic singularities when one axis of rotation becomes aligned with another axis of rotation.

Rosheim developed several robot actuators, such as the “Compact Robot Wrist Actuator” (U.S. Pat. No. 4,686,866) and several versions of the “OmniWrist”, which improved on the range of motion of previous actuators. The “OmniWrist” utilized two coupled universal joints in order to achieve a full hemisphere, singularity free range of motion. Rosheim developed several OmniWrist variants, some utilizing gears and others utilizing linkages to couple the two universal joints and drive the motion. However, these designs can have low stiffness in some configurations, exhibit backlash, and have a high part count.

The present invention overcomes some of the drawbacks of the OmniWrist designs while still achieving singularity-free hemispherical motion (for the three-dimensional embodiments). In its simplest form the present invention uses a drive cable across two pin joints. More complex versions employ cables across two universal joints to drive two output degrees of freedom. The design achieves a high degree of stiffness, low backlash, and reduced part count as compared to previous robot joint designs.

### BRIEF SUMMARY OF THE INVENTION

The present invention comprises a robotic joint wherein a second link is driven relative to a first link. An intermediate link connects the second link to the first link. The first link includes a first arcuate surface centered on a first axis. The second link includes a second arcuate surface centered on a second axis. The radius of the first arcuate surface is equal to the radius of the second arcuate surface. The intermediate link is pivotally connected to the first axis and pivotally connected to the second axis.

First and second cables are provided. The first cable runs around the first arcuate surface in a first direction and runs around the second arcuate surface in a second direction that is opposite to the first direction. The second cable runs around the second arcuate surface in the first direction and around the first arcuate surface in the second direction. Tension is maintained on both cables.

An actuator is connected between the first link and the intermediate link, in order to drive the position of the intermediate link with respect to the first link. The angular motion of the intermediate link is doubled in the motion of the second link. The first and second cables produce a high degree of stiffness and minimize backlash. More complex embodiments incorporate a comparable arrangement of cables across two universal joints to drive two output degrees of freedom.

### BRIEF DESCRIPTION OF THE SEVERAL VIEWS OF THE DRAWINGS

FIG. 1 is an exploded perspective view, showing a two-dimensional version of the inventive robotic joint.

FIG. 2 shows the embodiment of FIG. 1 in an assembled state.

FIG. 3 is a plan view, showing a “home” position of the joint of FIG. 2.

FIG. 4 is a plan view, showing an “extended” position for the joint of FIG. 2.

FIG. 5 is a plan view, showing the operation of the cables in a retraction stroke.

FIG. 6 is a plan view, showing the operation of the cables in a retraction stroke.

FIG. 7 is a sectional elevation view, showing the interaction of the first and second cables with the first and second arcuate surfaces.

FIG. 8 is a plan view, showing an alternate embodiment for a two-dimensional joint.

### REFERENCE NUMERALS IN THE DRAWINGS

10 joint
12 first link
14 second link
16 first cable
18 second cable
20 anchor
22 anchor
24 anchor
26 anchor
28 first axis
30 second axis
32 actuator axis
34 first plate
36 second plate
38 arcuate surface
40 arcuate surface
42 cable groove
43 cable groove
44 cable groove
45 cable groove
46 first pin
48 second pin
50 actuator pin
52 actuator
54 mounting pin
56 passage
58 passage

### DETAILED DESCRIPTION OF THE INVENTION

The inventive joint described in this patent application can be embodied in many different ways, including two-dimensional embodiments and three-dimensional embodiments. It is easiest to understand the two dimensional embodiments and so this description focuses on those embodiments. The term “two-dimensional” means that the motion of the links lies in a single plane.

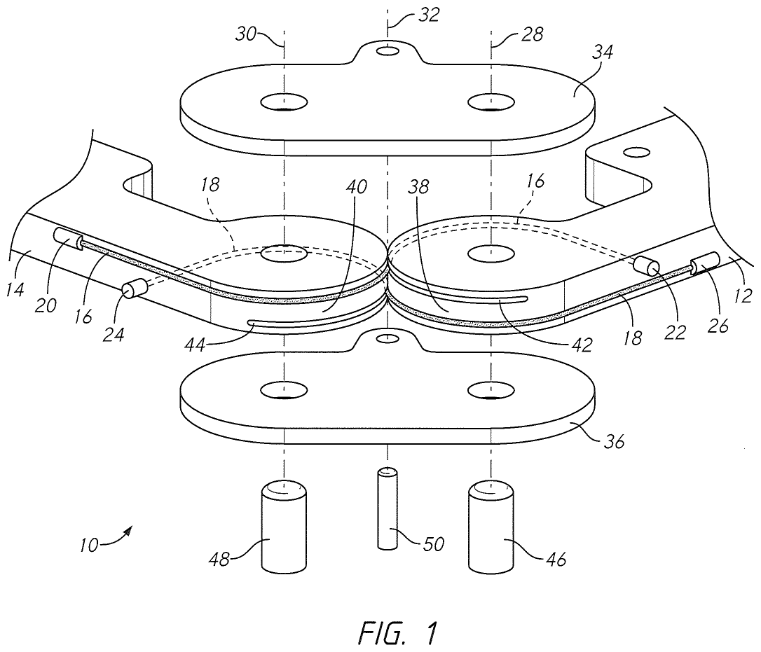

FIG. 1 provides an exploded view of an exemplary embodiment of joint 10. The general objective is to provide a controlled motion of second link 14 with respect to first link 12. First link 12 may be a relatively stationary component—such as the chassis of a robot—or it may be a moving component that is part of a larger joint assembly.

Second link 14 is connected to first link 12 by an intermediate link. In this example the intermediate link is created by an assembly of first plate 34 and second plate 36. The first and second links are arranged in a common plane as shown. First plate 34 is placed on the top of the first and second links (“top” and other directional terms referring solely to the orientation shown in the view). Second plate 36 is moved upward against the bottom of the first and second links.

First axis 28 passes perpendicularly through first link 12 as shown. Second axis 30 passes perpendicularly through second link 14. A pivotal connection is created between plates 34, 36 and first link 12 by passing first pin 46 through corresponding holes in the components—the holes being aligned with first axis 28. A corresponding pivotal connection is created between plates 34, 36 and second link 14 by passing second pin 48 through the holes aligned with second axis 30.

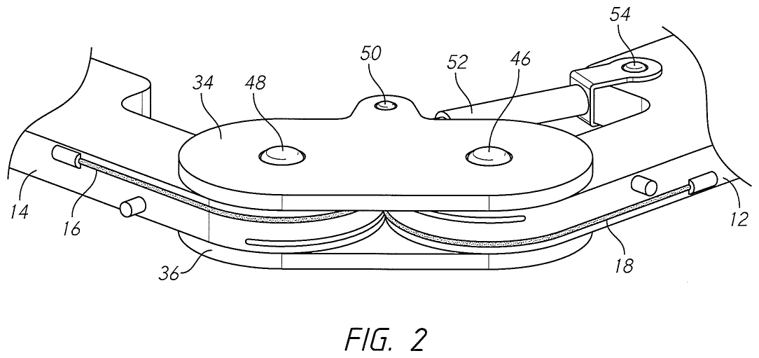

The pivotal joints are depicted very simply. In other embodiments the pivotal joints will include rotary bearings and retaining features such as snap rings. FIG. 2 shows the same components in an assembled state. The reader will observe how first plate 34 and second plate 36 act like a single pivoting component known as an “intermediate link.” It is of course possible to create this intermediate link as a single piece rather than an assembly of two plates.

Actuator 52 applies force between mounting pin 54 (connecting one end of the actuator to first link 12) and actuator pin 50 (connecting the opposite end of the actuator to the intermediate link). Returning to FIG. 1, the reader will note how the plates 34, 36 include an actuator axis 32 through a pair of aligned holes. Actuator pin 50 is passed through the holes in the plates and through a rod eye in an extendable rod contained within the actuator. First link 12 also includes a hole configured to receive a second pin for mounting the cylinder end of the actuator. Looking again at FIG. 2—mounting pin 54 attaches the cylinder end of the actuator and actuator pin 50 attaches the rod end of the actuator.

The use of tension cables across the joint is an important aspect of the present invention. These cables are shown in FIG. 1. First cable 16 is a flexible cable preferably having substantial longitudinal stiffness. In this example each end of the first cable is terminated in an enlarged anchor. A first end of first cable 16 is attached to first link 12 via anchor 22. A second end of first cable 16 is attached to second link 14 via anchor 20.

A first end of second cable 18 is attached to second link 14 via anchor 24. A second end of second cable 18 is attached to first link 12 via anchor 26. The cables wrap around arcuate surfaces on each of the links. First link 12 has arcuate surface 38—which is centered on first axis 28. Second link 14 has arcuate surface 40—which is centered on second axis 30. Cable grooves are preferably provided in these arcuate surfaces. The cable grooves receive and positively locate the cables. In the view of FIG. 1, the reader will observe the presence of cable groove 42 in arcuate surface 38 and the presence of cable groove 44 in arcuate surface 40.

First cable 16 starts at anchor 22. It travels through a transverse passage through first link 12 and then wraps in a counterclockwise direction around arcuate surface 38 of first link 12. It then transfers to arcuate surface 40 of second link 14 until finally terminating in anchor 20 (which is attached to the second link). First cable 16 wraps in a clockwise direction around arcuate surface 40. The reader should note that the terms “clockwise” and “counterclockwise” are arbitrary depending on which end of a cable is considered a first end or a second end. In the convention of this disclosure, anchor 22 is the first end of first cable 16 and anchor 20 is its second end. Using that convention, as one proceeds from the first end of first cable 16 toward the second end of first cable 16, first cable 16 wraps in a counterclockwise direction around arcuate surface 38 and in a clockwise direction around arcuate surface 40.

A first end of second cable 18 is connected to second link 14 at anchor 24. Second cable 18 travels through a transverse passage through second link 14 and then wraps in a clockwise direction around arcuate surface 40. Second cable 18 then wraps in a counterclockwise direction around arcuate surface 38. The second end of second cable 18 is then connected to first link 12 at anchor 26.

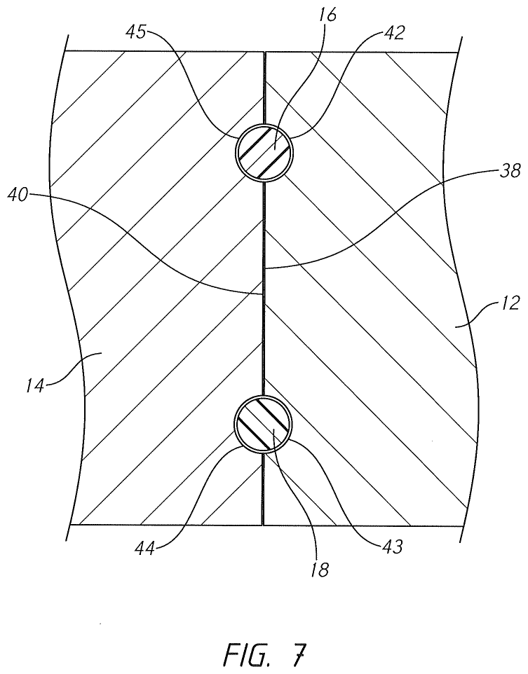

As stated previously, grooves are preferably provided to receive and positively locate the cables as they travel about the arcuate surfaces. FIG. 7 shows a sectional elevation view through the two arcuate surfaces 38, 40 at the point they meet. First cable 16 lies within cable groove 42 of first link 12 and within cable groove 45 of second link 14. Second cable 18 lies within cable groove 43 of first link 12 and within cable groove 44 of second link 14.

The cables themselves are preferably made of filaments having a high longitudinal stiffness. A construction of thin steel strands can be used. Even more advantageously a construction of high-strength synthetic filaments can be used. Many different materials can be used for these filaments. These include DYNEEMA (ultra-high-molecular-weight polyethylene), SPECTRA (ultra-high-molecular-weight polyethylene), TECHNORA (aramid), TWARON (p-phenylene terephthalamide), KEVLAR (para-aramid synthetic fiber), VECTRAN (a fiber spun from liquid-crystal polymer), PBO (poly(p-phenylene-2,6-benzobisoxazole)), carbon fiber, and glass fiber (among many others). In general the individual filaments have a thickness that is less than that of human hair. The filaments are very strong in tension and have a very high modulus of elasticity, but they are not very tough. They also tend to have low surface friction. Surface friction is not necessary in the present invention, but it is preferable to provide the synthetic filaments with a jacket or coating to minimize wear and retain the cross-sectional organization of each cable.

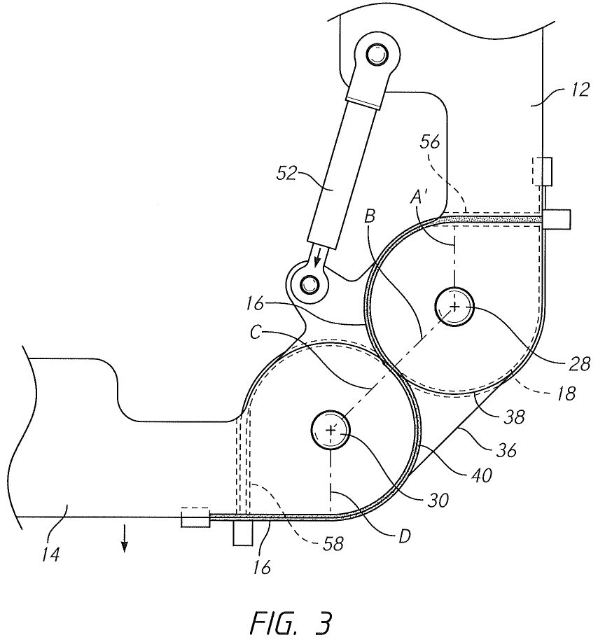

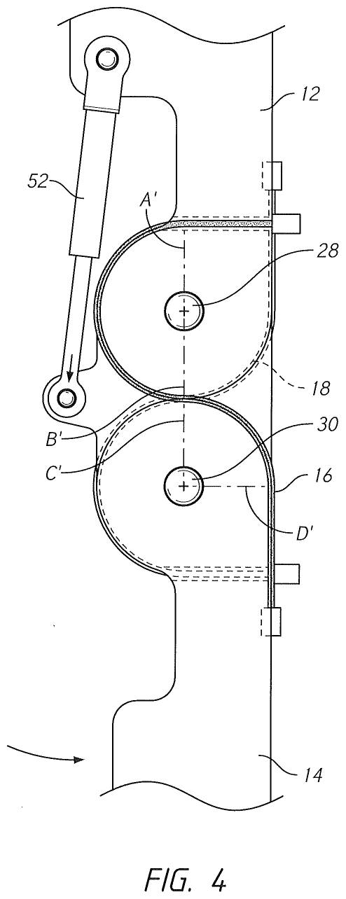

FIGS. 3 through 6 depict the operation of the inventive joint. FIGS. 3 and 4 show the motion of the links when the actuator extends from a retracted position to an extended position. The reader will note in FIG. 3 that actuator 52 is in a retracted state. First plate 34 has been removed so that the internal details may be easily seen. The intermediate link (represented by second plate 36) is angularly offset −45 degrees from the orientation of first link 12 (the counterclockwise direction being deemed positive). Second link 14 is angularly offset −90 degrees from first link 12.

In this example actuator 52 is a cylinder with an extendable rod (such as an air cylinder or a hydraulic cylinder commonly includes). The arrow shown on actuator 52 indicates that the rod has just started traveling outward from the cylinder in the direction indicated.

The extension of actuator 52 puts first cable 16 in tension. First cable 16 is shown as a thick black line in the view, with second cable 18 being shown as a dashed line. First cable 16 travels through passage 56 before coming in contact with—and wrapping around a part of—arcuate surface 38. The tension in first cable 16 is transmitted to anchor 20 in second link 14. The transmitted tension becomes a moment pivoting second link 14 counterclockwise about second axis 30. Of course, the intermediate link is being pivoted counterclockwise about first axis 28 via the extension of actuator 52.

The result is shown in FIG. 4. The intermediate link (represented by second plate 36) has rotated 45 degrees in the counterclockwise direction. Second link 14, however, has rotated 90 degrees in the counterclockwise direction. The inventive joint has thereby doubled the angular motion of second link 14 compared to the angular motion of the driven link (the intermediate link represented by second plate 36).

Throughout this motion first cable 16 has remained in tension. The geometry of the joint is important to the maintenance of tension, as can be seen by comparing FIGS. 3 and 4. The radius of arcuate surface 40 is equal to the radius of arcuate surface 38.

In FIG. 3, the reader will note that first cable 16 wraps around arcuate surface 38 from Point A to Point B. The arcuate distance is 135 degrees. First cable 16 then wraps around arcuate surface 40 from Point C to Point D. This second arcuate distance is also 135 degrees. Thus, the total travel around an arcuate surface having a constant radius is 270 degrees (135+135).

In the position shown in FIG. 4, fist cable 16 wraps around arcuate surface 38 from Point A to Point B′— an arcuate distance of 180 degrees. First cable 16 wraps around arcuate surface 40 from Point C′ to Point D′—a distance of 90 degrees.

The travel around arcuate surface 38 is 135 degrees. Thus, the total travel around an arcuate surface having a constant radius is again 270 degrees (180+90). The use of the arcuate surfaces having an equal radius means that the length of the first cable's travel remains constant and tension is maintained on the first cable throughout. During the motion between the states shown in FIG. 3 and FIG. 4, the same linear amount of first cable 16 that is fed off of arcuate surface 38 is received onto arcuate surface 40. The total “run” of the cable remains constant and the cable tension therefore remains constant.

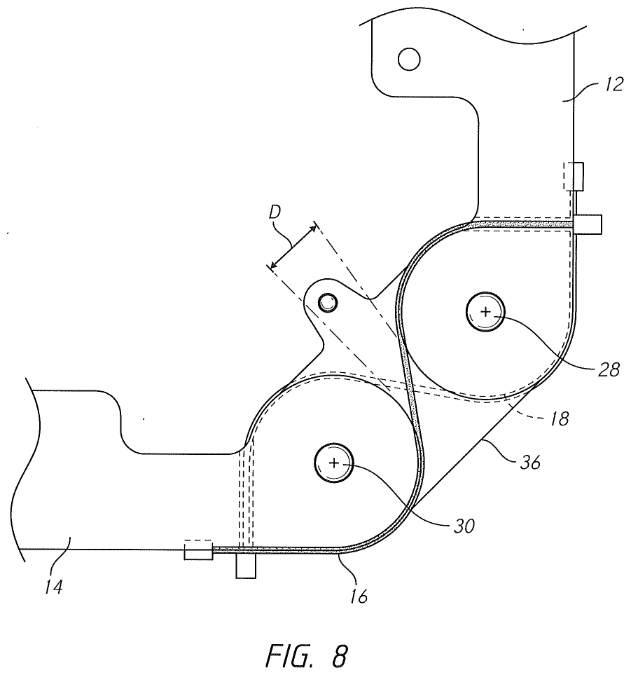

Returning to FIG. 3, the reader will note that second cable 18 follows an opposite path to first cable 16. The first end of second cable 18 is attached to second link 14 at anchor 24. From this attachment point the second cable travels through passage 58, then clockwise around arcuate surface 40, then counterclockwise around arcuate surface 38. The two cables thereby form a partial “FIG. 8.”

The second cable does not produce the forces for moving second link 14 during the extension of actuator 52. However, the second cable does restrict backlash. It keeps the moving joint tight, and is therefore an important feature.

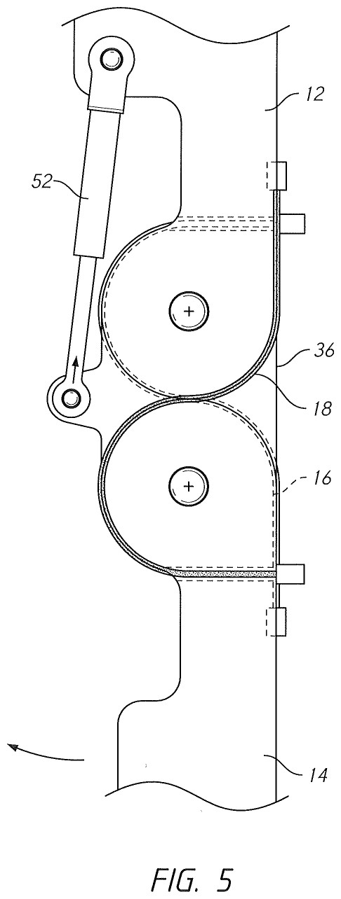

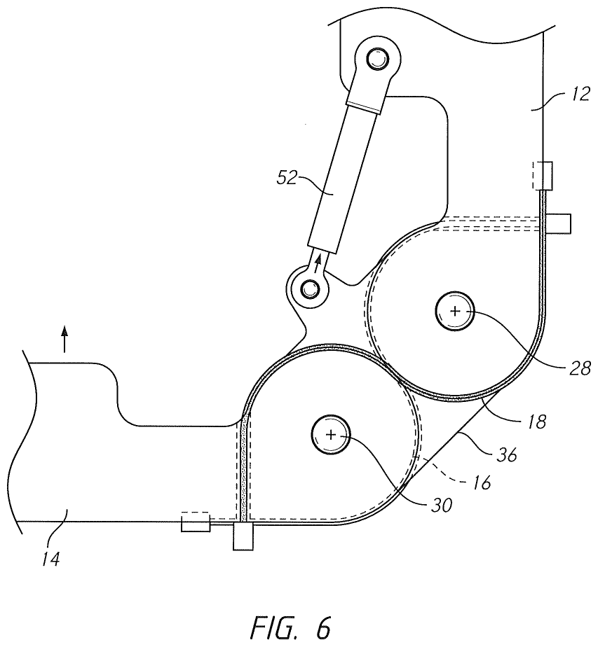

FIGS. 5 and 6 illustrate the retraction cycle, in which the roles of the two cables are reversed. In FIG. 5, second link 14 is fully extended. Actuator 52 has just started the retraction cycle—as indicated by the arrow. Second cable 36 is placed in tension. The tension pulls on anchor 24 (see FIG. 1) thereby placing a clockwise moment about second axis 30. This moment rotates second link 14 in a clockwise direction. The intermediate link—represented by second plate 36—is rotated in a clockwise direction by the retraction of actuator 52.

FIG. 6 shows the completion of the retraction cycle. Second link 14 has been rotated 90 degrees in the clockwise direction, while the intermediate link has only been rotated 45 degrees in the clockwise direction. Second cable 18 has been maintained in tension throughout and has transmitted the moving forces to second link 14. First cable 16 (shown as a dashed line in FIGS. 5 and 6) has served to minimize backlash during the retraction cycle and has held the joint tight.

In the embodiment of FIGS. 1-7 the two arcuate surfaces have been in contact with each other—or very nearly in contact with each other. This is not a necessary feature of the invention. FIG. 8 shows another embodiment in which the two nearest points on the two arcuate surfaces are separated by a distance “D.” The intermediate link and second link 14 will still behave in the same manner, though the overall dimensions of the joint have been increased by the enlargement of the distance between first axis 28 and second axis 30.

The anchoring of the free ends of the cables is a significant feature of the invention. In the embodiments shown, an anchor attached to each end of each cable bears against a corresponding shoulder on one of the two links. It is preferable to maintain tension on the cables at all times—as slack permits unwanted motion. Shims can be used between the anchors and the links to create the desired tension. A threaded connection can also be used, where each anchor includes a thrust bearing and a threaded portion that can be turned to adjust the anchor's overall length. It is also possible to include turnbuckle devices to adjust the cable tension.

The use of anchors to positively hold each end of the cable eliminates the need for any frictional engagement between the cables and the links. Forces are transmitted through the anchors rather than cable-to-link friction. The attachment of each cable to its corresponding anchor can be made by potting the cable filaments into an expanding cavity within the anchor. The connection can also be made using spike-and-cone hardware. Numerous other features and variations are possible, including:

1. The use of a linear actuator should not be viewed as limiting. A gear drive between the first link and the intermediate link could be used. Many other types of actuators could be used as well.

2. The cables can include parallel filaments, helically-wound filaments, braided filaments, or some other construction.

3. Cable grooves need not be used where there is adequate clearance between the two arcuate surfaces,

4. A sophisticated motion controller can be used to precisely control the motion of the joint via the motion of the actuator.

5. Braking devices can be applied across one or more of the pivoting joints.

6. The same cable construction can be used to create three-dimensional joints. As an example, the cables can be applied across a U-joint, where the axis of a first joint is orthogonal to an axis of a second joint. The routing of the cables themselves need not lie in a single plane for these more sophisticated embodiments.

Although the preceding description contains significant detail, it should not be construed as limiting the scope of the invention but rather as providing illustrations of the preferred embodiments of the invention. Those skilled in the art will be able to devise many other embodiments that carry out the present invention. Thus, the language used in the claims shall define the invention rather than the specific embodiments provided.

Having described our invention, we claim:

1. A robotic joint, comprising:
(a) a first link having a first axis and a first arcuate surface centered on said first axis;
(b) a second link having a second axis and a second arcuate surface centered on said second axis;
(c) wherein a first radius of said first arcuate surface is equal to a second radius of said second arcuate surface;
(d) an intermediate link, wherein said intermediate link is pivotally connected to said first link at said first axis and pivotally connected to said second link at said second axis;
(e) an actuator configured to vary an angular relationship between said first link and said intermediate link;
(f) a first cable having a first end and a second end, wherein,
(i) said first end of said first cable is anchored to said first link,
(ii) said second end of said first cable is anchored to said second link,
(iii) said first cable runs around said first arcuate surface in a first direction,
(iv) said first cable runs around said second arcuate surface in a second direction that is opposite to said first direction;
(g) a second cable having a first end and a second end, wherein,
(i) said first end of said second cable is anchored to said second link,
(ii) said second end of said second cable is anchored to said first link,
(iii) said second cable runs around said second arcuate surface in said second direction, and
(iv) said second cable runs around said first arcuate surface in said first direction.

2. A robotic joint as recited in claim 1, wherein said first and second cables lie in cable grooves in said first and second arcuate surfaces.

3. A robotic joint as recited in claim 2, wherein second cable is offset from said first cable in a direction that is parallel to said first.

4. A robotic joint as recited in claim 1, wherein said second axis is parallel to said first axis.

5. A robotic joint as recited in claim 1, wherein said first and second cables include high-stiffness synthetic filaments.

6. A robotic joint as recited in claim 1, wherein tension is maintained on said first and second cables.

7. A robotic joint as recited in claim 1, wherein said intermediate link includes a top plate and a bottom plate.

8. A robotic joint as recited in claim 1, wherein said actuator is a linear actuator.

9. A robotic joint as recited in claim 4, wherein said second axis is parallel to said first axis.

10. A robotic joint as recited in claim 6, wherein said second axis is parallel to said first axis

11. A robotic joint, comprising:
(a) a first link having a first axis and a first arcuate surface centered on said first axis;
(b) a second link having a second axis and a second arcuate surface centered on said second axis;
(c) wherein a first radius of said first arcuate surface is equal to a second radius of said second arcuate surface;
(d) an intermediate link, wherein said intermediate link is pivotally connected to said first link at said first axis and pivotally connected to said second link at said second axis;
(e) an actuator configured to move said intermediate link with respect to said first link;
(f) a first cable attached to said first link and said second link, wherein said first cable runs around said first arcuate surface in a first direction and around said second arcuate surface in a second direction that is opposite to said first direction; and
(g) a second cable attached to said first link and said second link, wherein said second cable runs around said second arcuate surface in said second direction and around said first arcuate surface in said first direction.

12. A robotic joint as recited in claim 11, wherein said first and second cables lie in cable grooves in said first and second arcuate surfaces.

13. A robotic joint as recited in claim 12, wherein second cable is offset from said first cable in a direction that is parallel to said first.

14. A robotic joint as recited in claim 11, wherein said second axis is parallel to said first axis.

15. A robotic joint as recited in claim 11, wherein said first and second cables include high-stiffness synthetic filaments.

16. A robotic joint as recited in claim 11, wherein tension is maintained on said first and second cables.

17. A robotic joint as recited in claim 11, wherein said intermediate link includes a top plate and a bottom plate.

18. A robotic joint as recited in claim 11, wherein said actuator is a linear actuator.

19. A robotic joint as recited in claim 14, wherein said second axis is parallel to said first axis.

20. A robotic joint as recited in claim 16, wherein said second axis is parallel to said first axis
